(19) United States
(12) Patent Application Publication
(10) Pub. No.: US 2008/0189661 A1
(43) Pub. Date: Aug. 7, 2008

(54) VIDEO USER INTERFACE

(75) Inventors: Craig D. Gundlach, McAllen, TX (US); Bradley Kyle Stephens, McAllen, TX (US); Ralph Flores, McAllen, TX (US)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: Jazzbo Technology Inc., McAllen, TX (US)

(21) Appl. No.: 12/025,995

(22) Filed: Feb. 5, 2008

Related U.S. Application Data
(60) Provisional application No. 60/888,367, filed on Feb. 6, 2007.
(60) Provisional application No. 60/888,358, filed on Feb. 6, 2007.
(60) Provisional application No. 60/888,383, filed on Feb. 6, 2007.

(51) Int. Cl. G06F 3/00; G06K 9/00

(52) U.S. Cl. 715/863; 382/103

(57) ABSTRACT

Embodiments of the invention provide methods and systems for providing user input to a system. For example, according to one embodiment, a video camera can be used to capture an image of a user and a background scene. Movements of the user can be detected from the video image and correlated to a user interface after initial calibration. Through this correlation, movements of the user can be translated into manipulations of the user interface. These manipulations of the user interface can in turn be used to control the system.

### CROSS-REFERENCES TO RELATED APPLICATIONS

This application claims the benefit of U.S. Provisional Application No. 60/888,367, filed Feb. 6, 2007, entitled ACTOR FACTOR FOR A USER INTERFACE, U.S. Provisional Application No. 60/888,358, filed Feb. 6, 2007, entitled HIT-POINT CLUSTERS FOR A USER INTERFACE, and U.S. Provisional Application No. 60/888,383, filed Feb. 6, 2007, entitled LIGHT-POINT CALIBRATIONS FOR A USER INTERFACE of which the complete disclosure of each is incorporated herein by reference for all purposes.

### BACKGROUND OF THE INVENTION

Embodiments of the present invention relate generally to user interfaces for computer systems and/or applications and more particularly to a user interface using video as an input.

### BRIEF SUMMARY OF THE INVENTION

Embodiments of the present invention provide methods, systems and machine-readable medium for providing user input to a system and/or application. According to one embodiment, a method for providing user input can include receiving an image of a scene from a video input such as a camera. Movement of a user within the scene can be detected based on the image of the user and the background of the scene. A determination can be made as to whether the movement of the user corresponds to a target element of a user interface for the system. In response to determining that the movement of the user corresponds to the target element of the user interface, the target element of the user interface can be manipulated according to the movement of the user.

According to another embodiment, a method for reducing unintended activation of a user interface using video as an input can include receiving the video input from a video input such as a camera, identifying a user within a field of view of the camera, determining a user area around the user, detecting movement in the field of view of the camera, and in response to the movement occurring outside of the user area, temporarily disabling the user interface.

According to yet another embodiment, a method for reducing errors in a user interface using a video device such as a camera as an input device can include detecting lighting conditions over a field of view of the camera. The field of view can be divided into a number of zones. Sensitivity for detecting movement within each zone can be adjusted based on the lighting conditions of that zone.

### BRIEF DESCRIPTION OF THE DRAWINGS

FIG. 1A illustrates a system according to one embodiment of the present invention.

FIG. 1B illustrates details of the exemplary display illustrated in FIG. 1B.

FIG. 2 is a block diagram illustrating an exemplary computer system upon which embodiments of the present invention may be implemented.

FIG. 3 illustrates logical division of the user interface into multiple layers according to one embodiment of the present invention.

FIG. 4 is a flowchart illustrating a process for receiving user input according to one embodiment of the present invention.

FIG. 5 is a flowchart illustrating additional details of a process for receiving user input according to one embodiment of the present invention.

FIG. 6 is a flowchart illustrating a process for reducing unintended activation of a user interface using video as an input according to one embodiment of the present invention.

FIG. 7 is a flowchart illustrating additional details of a process for identifying a user according to one embodiment of the present invention.

FIG. 8 is a flowchart illustrating a process for light-point calibration according to one embodiment of the present invention.

FIG. 9 is a flowchart illustrating additional details of a process for light-point calibration according to one embodiment of the present invention.

### DETAILED DESCRIPTION OF THE INVENTION

In the following description, for the purposes of explanation, numerous specific details are set forth in order to provide a thorough understanding of various embodiments of the present invention. It will be apparent, however, to one skilled in the art that embodiments of the present invention may be practiced without some of these specific details. In other instances, well-known structures and devices are shown in block diagram form.

The ensuing description provides exemplary embodiments only, and is not intended to limit the scope, applicability, or configuration of the disclosure. Rather, the ensuing description of the exemplary embodiments will provide those skilled in the art with an enabling description for implementing an exemplary embodiment. It should be understood that various changes may be made in the function and arrangement of elements without departing from the spirit and scope of the invention as set forth in the appended claims.

Specific details are given in the following description to provide a thorough understanding of the embodiments. However, it will be understood by one of ordinary skill in the art that the embodiments may be practiced without these specific details. For example, circuits, systems, networks, processes, and other components may be shown as components in block diagram form in order not to obscure the embodiments in unnecessary detail. In other instances, well-known circuits, processes, algorithms, structure s, and techniques may be shown without unnecessary detail in order to avoid obscuring the embodiments.

Also, it is noted that individual embodiments may be described as a process which is depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be re-arranged. A process is terminated when its operations are completed, but could have additional steps not included in a figure. A process may correspond to a method, a function, a procedure, a subroutine, a subprogram, etc. When a process corresponds to a function, its termination can correspond to a return of the function to the calling function or the main function.

The term “machine-readable medium” includes, but is not limited to portable or fixed storage devices, optical storage devices, wireless channels and various other mediums capable of storing, containing or carrying instruction(s) and/or data. A code segment or machine-executable instructions may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted via any suitable means including memory sharing, message passing, token passing, network transmission, etc.

Furthermore, embodiments may be implemented by hardware, software, firmware, middleware, microcode, hardware description languages, or any combination thereof. When implemented in software, firmware, middleware or microcode, the program code or code segments to perform the necessary tasks may be stored in a machine readable medium. A processor(s) may perform the necessary tasks.

Embodiments of the invention provide methods and systems for providing user input to a system. For example, according to one embodiment, a video camera can be used to capture an image of a user and a background scene. Movements of the user can be detected from the video image and correlated to a user interface after initial calibration. Through this correlation, movements of the user can be translated into manipulations of the user interface. These manipulations of the user interface can in turn be used to control the system.

In some cases, due to movement occurring within the field of view of the video camera other than the user, false detections and unintended activation of the user interface may occur. Therefore, embodiments of the present invention can provide for reducing unintended activation of a user interface using video as an input. Generally speaking, reducing unintended activation of a user interface using video as an input can include receiving the video input from a camera, identifying a user within a field of view of the camera, determining a user area around the user, detecting movement in the field of view of the camera, and in response to the movement occurring outside of the user area, temporarily disabling the user interface.

In some cases, due to lighting conditions within an area or within the field of view of the camera, false detection of movement may occur. Therefore, embodiments of the present invention can provide for reducing errors in a user interface using a camera as an input device. Generally speaking, reducing errors in a user interface using a camera as an input device can include detecting lighting conditions over a field of view of the camera. The field of view can be divided into a number of zones. Sensitivity for detecting movement within each zone can be adjusted based on the lighting conditions of that zone

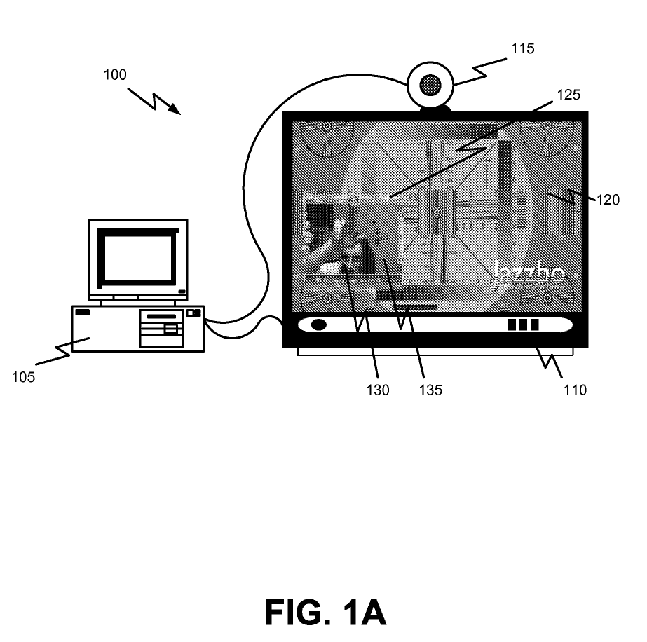

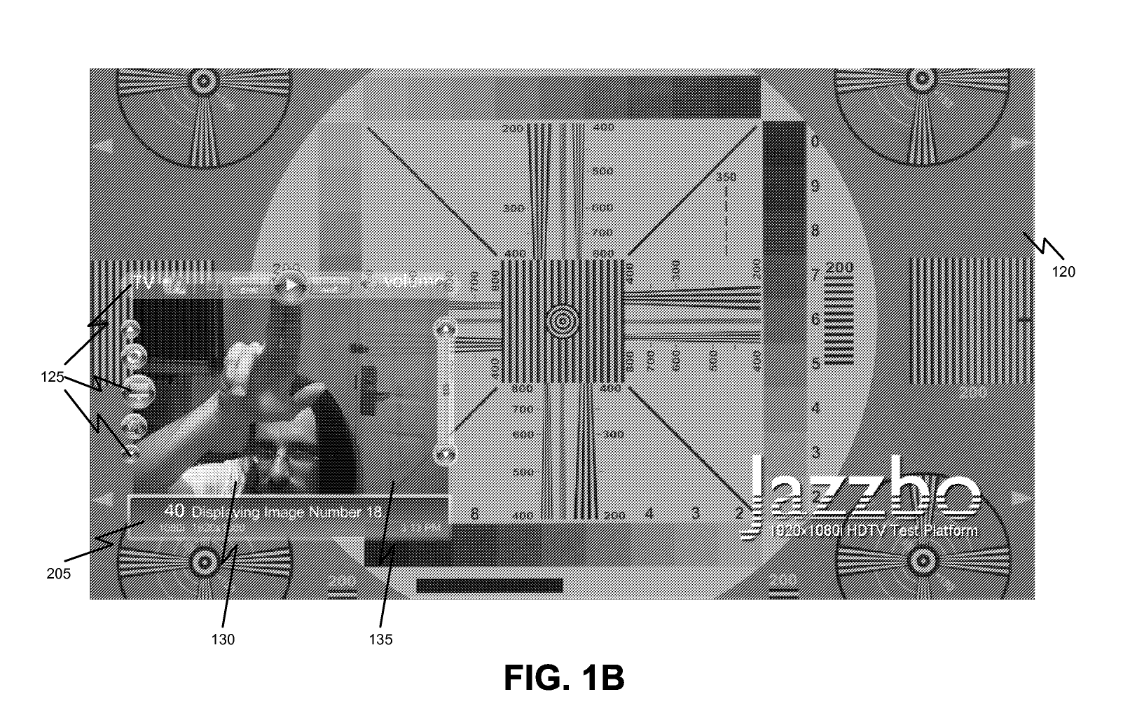

FIG. 1 illustrates a system according to one embodiment of the present invention. In this example, the system 100 includes a computer 105, a television or video monitor 110, and a video camera 115. Generally speaking, a user positioned in front of the video camera 115 can be monitored by software executed by the computer 105 which also receives a video feed from the camera 115. Movements of the user can be detected by this software and used to control the television 110, the computer 105, or another device with which the software may be in communication.

According to one embodiment, the computer 105 can be adapted to receive an image 130 of the user from a video input device such as a camera 115. According to one embodiment, upon start-up or initialization of the computer system 105 and/or the software executing thereon for control of the system as described herein, an initial calibration procedure may be executed. Generally speaking this initial calibration procedure can calibrate a number of hit-point clusters. As will be seen, these hit-point clusters can be used to detect a movement of the user. The initial calibration procedure can adjust the tolerance of the hit-point clusters for the camera's jitter. Additional details of the hit-point clusters and the initial calibration procedure will be described below.

Based on the image 130 of the user, and the background scene 135, the computer 105 can detect movement of the user. A determination can be made as to whether the movement of the user corresponds to a target element of a user interface for the system or is just general movement of the user in the scene. For example, the computer 105 can display on the television 110 the image 130 of the user and the background scene 135 received from the video camera 115. The computer 105 can also display a set of user interface elements 125 overlaid on the image 130 of the user and background scene 135. Movement of the user can be correlated to the elements of the user interface 125 as displayed on the television 110. In response to determining that the movement of the user corresponds to a target element of the user interface, the target element of the user interface can be manipulated according to the movement of the user.

In other words, the user interface may include, for example, a scrollbar or buttons for controlling volume or channel selection of the television. The user, while viewing the television, can move his hand to appear to touch one of the buttons or “grab” and “move” the slider of the scrollbar. In response to these movements by the user, the computer 105 can in turn control the television 110 accordingly, e.g., change the channel, raise or lower the volume, etc.

According to one embodiment, the image 130 of the user, the background scene 135 and the visual representation of the user interface elements 125 may be displayed in response to a movement by the user. So, for example, the television 110 or video display may display some content such as a television show, movie, or other display 120. When the user moves, as captured by the camera 115 and detected by the software of the computer system 105, a window or picture-in-picture display can be opened on the display 120 to show, perhaps temporarily, the image 130 of the user, the background scene 135 and the visual representations of the user interface elements 125. In this way, the user can move to “touch” or manipulate the elements of the user interface.

FIG. 1B provides another view of the display 120 presented on the television 110 of the system 100 of FIG. 1A. In this example, the display includes a window 205 or picture-in-picture opened in response to a movement by the user. The window 205 includes the image 130 of the user, the background scene 135 and the visual representations of the user interface elements 125. As noted above, movement of the user can be correlated to the elements of the user interface 125 as displayed on the television 110. In response to determining that the movement of the user corresponds to a target element of the user interface, the target element of the user interface can be manipulated according to the movement of the user. Thus, the user, while viewing the display 120 of the television, can move his hand to appear to “touch” one of the buttons or “grab” and “move” the slider of the scrollbar. In response to these movements by the user, the computer 105 can in turn control the television 110 accordingly, e.g., change the channel, raise or lower the volume, etc.

It should be understood that, in other embodiments, the system may provide for controlling different devices and/or software. For example, in some implementations, embodiments of the present invention may be used to control or interact with a video game. In another implementation, embodiments of the present invention may be used to control or interact with an operating system or application programs executed by the computer 105. In yet other implementations, embodiments of the present invention may be used to control devices and/or software of remote systems communicatively coupled with the computer 105 via a local area network, wide area network, the Internet, etc. It should also be understood that television 110 is optional and may be used in addition to or instead of another video monitor coupled to the computer 105.

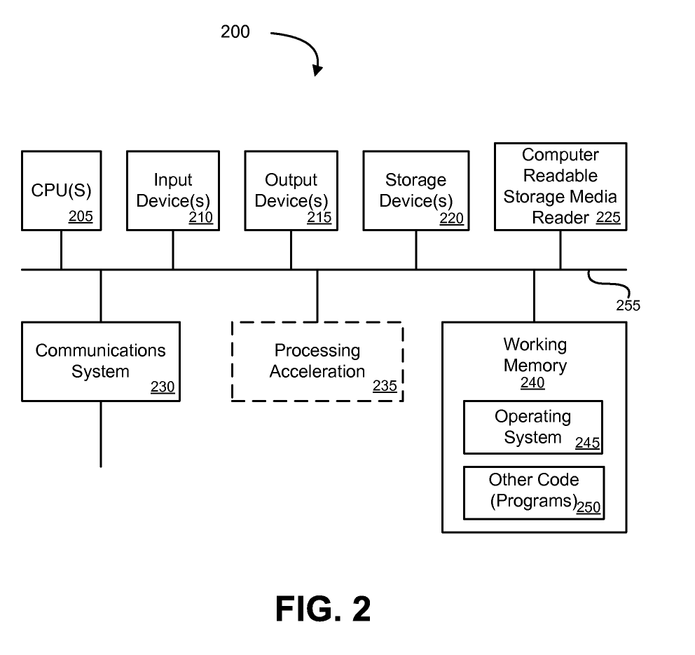

FIG. 2 is a block diagram illustrating an exemplary computer system upon which embodiments of the present invention may be implemented. This example illustrates a computer system 200 that may be used to implement the computer 100 as discussed above. The computer system 200 is shown comprising hardware elements that may be electrically coupled via a bus 255. The hardware elements may include one or more central processing units (CPUs) 205; one or more input devices 210 (e.g., a scan device, a mouse, a keyboard, a video camera such as camera 115 discussed above, etc.); and one or more output devices 215 (e.g., a display device, a printer, television 110 as discussed above, etc.). The computer system 200 may also include one or more storage device 220. By way of example, storage device(s) 220 may be disk drives, optical storage devices, solid-state storage device such as a random access memory (“RAM”) and/or a read-only memory (“ROM”), which can be programmable, flash-updateable and/or the like.

The computer system 200 may additionally include a computer-readable storage media reader 225; a communications system 230 (e.g., a modem, a network card (wireless or wired), an infra-red communication device, etc.); and working memory 240, which may include RAM and ROM devices as described above communicatively coupled with and readable by CPU(s) 205. In some embodiments, the computer system 200 may also include a processing acceleration unit 235, which can include a DSP, a special-purpose processor and/or the like.

The computer-readable storage media reader 225 can further be connected to a computer-readable storage medium, together (and, optionally, in combination with storage device(s) 220) comprehensively representing remote, local, fixed, and/or removable storage devices plus storage media for temporarily and/or more permanently containing computer-readable information. The communications system 230 may permit data to be exchanged with a network and/or any other computer or other type of device.

The computer system 200 may also comprise software elements, shown as being currently located within a working memory 240, including an operating system 245 and/or other code 250, such as an application program. The application programs may implement the methods of the invention as described herein. It should be appreciated that alternate embodiments of a computer system 200 may have numerous variations from that described above. For example, customized hardware might also be used and/or particular elements might be implemented in hardware, software (including portable software, such as applets), or both. Further, connection to other computing devices such as network input/output devices may be employed.

As noted above, software of the computer system 200 can implement a method for providing user input to the system 200. The method can include receiving an image of a user and background scene data from a camera. Movement of the user can be detected based on the image of the user and the background scene. A determination can be made as to whether the movement of the user corresponds to a target element of a user interface for the system. In response to determining that the movement of the user corresponds to the target element of the user interface, the target element of the user interface can be manipulated according to the movement of the user. According to one embodiment, to facilitate detection of a users movements and manipulation of elements of the user interface, the user interface may be logically divided into a number of layers with each logical layer representing different features and/or functions.

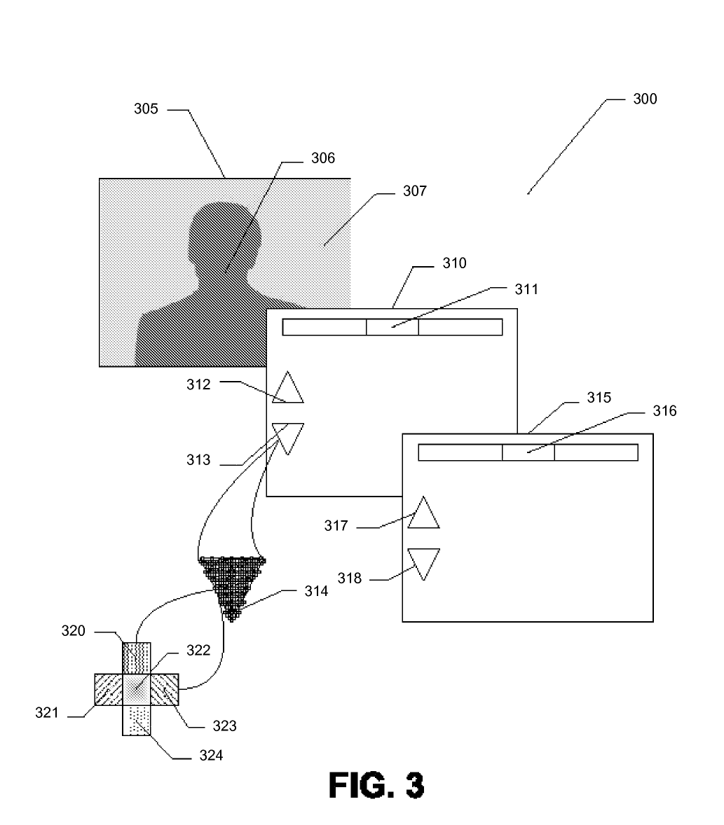

FIG. 3 illustrates an exemplary logical division of the user interface into multiple layers according to one embodiment of the present invention. In this example, the interface 300 includes three logical layers including an overlay layer 305, a hit-point layer 310, and an interface layer 315. The overlay layer 305, which may be displayed, can comprise the image of the user 306 and the background scene 307. That is, the overlay layer 305 can represent the image or scene captured by the video camera.

The interface layer 315 may also be displayed. Generally speaking, the interface layer 315 includes graphical representations of the elements 316-318 of the user interface such as buttons, scrollbars, menus, etc. The interface layer 315 can be overlaid on, i.e., displayed on top of, the overlay layer 305 thus giving the appearance of the controls floating above or about the user.

The interface 300 can also include a hit-point layer 310 corresponding to both the overlay layer 305 and the interface layer 315. The hit-point layer 310 can comprise a plurality of hit-point clusters 314 corresponding to each of the one or more user interface elements 316-318. That is, a number of hit-point clusters 314 can be arranged and/or located in areas 311-313 of the hit-point layer 310 corresponding to the location of the interface elements 316-318 of the interface layer 315. Additionally, hit-point clusters may be located elsewhere in the hit-point layer 310 depending upon where else it may be useful to detect movement.

The hit-point clusters can each comprise a number of hit-points representing a plurality of corresponding pixels 320-324 of the overlay layer 305. That is, each hit-point cluster 314 can comprise a number of hit-points with values representing the color or state of a corresponding pixel of the overlay layer 305. As noted above, according to one embodiment, upon start-up or initialization of the computer system and/or the software executing thereon for control of the system as described herein, an initial calibration procedure may be executed. More specifically, this initial calibration procedure can receive the image captured by the camera and, based on the image of the overlay layer 305, determine a color value for each of the pixels 320-324 of the hit-point clusters 314 of the hit-point layer 310. The color values of the individual pixels 320-324 can then be averaged together to determine an average color value for the hit-point cluster 314. A difference from this average value can then be determined for each pixel 320-324. This difference can then be used as a tolerance or sensitivity value for that pixel. That is, the difference from the average color value for the hit-point cluster for each pixel can be used as a limit for detecting changes in that pixel. In this way, the normal “jitter” associated with digital cameras can be factored out.

As noted above, each pixel represented by a hit-point of the hit-point cluster can have a current color value, i.e., RGB value. By monitoring these values, changes in the pixels of the overlay layer 305 can be detected at the hit-points. As noted above, these changes may be based on a tolerance determined during initial calibration of the system. That is, changes in the pixels of the overlay layer 305 may be detected if they exceed the tolerance level for the corresponding pixel of the hit-point layer 310. Furthermore, based on these changes, movement of the user can be detected. According to one embodiment, the plurality of corresponding pixels, i.e., the hit points 320-324, can be arranged in a grid pattern as shown, for example, in FIG. 3. Detecting movement of the user can then further comprises determining a direction of movement across the grid pattern based on changes to the corresponding pixels of the overlay layer 305. That is, based on changes to the pixels of the overlay layer 305, i.e., the current values relative to the previous values, and the known locations of those pixels, a direction of movement of the user can be determined.

Determining whether the movement of the user corresponds to the target element of the user interface can be based on detecting change to one or more hit-points of at least one hit-point cluster corresponding to the target element. As noted, detecting change to one or more hit-points of the at least one hit-point cluster can be based on changes to pixels of the overlay layer corresponding to the at least one hit-point cluster. Based on the changes detected by the hit-point clusters, the corresponding target element of the user interface can then be manipulated based on the motion. So, for example, if the user raises his hand and moves it to appear to touch a button, the hit-point clusters corresponding to the button will notify the system to indicate the changes caused by the user moving his hand into that area of the view. In response, the button can be pressed or actuated and a corresponding action can be taken to control the system.

It should be understood that while illustrated herein as comprising three logical layers, the interface may be logically divided into more or fewer layers depending upon the implementation. In some cases, in addition to the interface elements, other information may be displayed in an additional layer. For example, upon touching an element of the interface, a menu, tooltip, or other information may be displayed. This additional information may be represented in an additional logical layer.

It should also be understood that the arrangement, number, size, etc of the hit-points and hit-point clusters can vary significantly depending upon the implementation. For example, while discussed herein as representing individual pixels of the overlay layer, it should be understood that a hit-point may represent a group of multiple pixels. Furthermore, hit-point clusters may be placed throughout the hit-point layer rather than only in locations corresponding to elements of the interface layer.

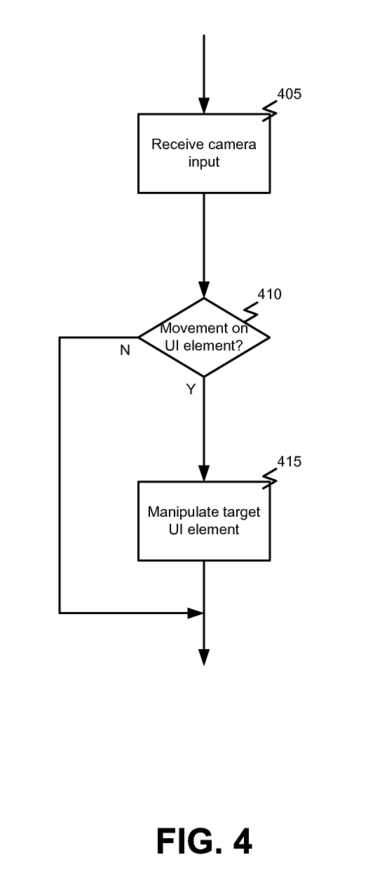

FIG. 4 is a flowchart illustrating a process for receiving user input according to one embodiment of the present invention. In this example, the process begins with receiving 405 an image of a user from a camera. Movement of the user can be detected based on the image of the user and a determination 410 can be made as to whether the movement of the user corresponds to a target element of a user interface for the system. In response to determining 410 that the movement of the user corresponds to the target element of the user interface, the target element of the user interface can be manipulated 415 according to the movement of the user. For example, as noted above, the user interface may include a scrollbar for controlling volume of the television. In such an example, manipulating 415 the user interface according to the movement of the user can comprise moving the slider of the scrollbar according to the movement of the user and controlling the television accordingly, e.g., raise or lower the volume.

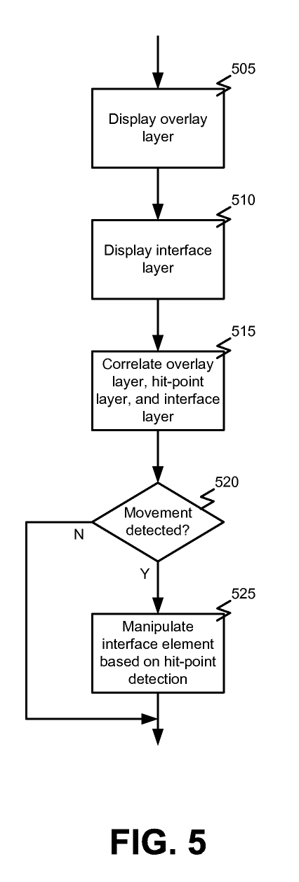

FIG. 5 is a flowchart illustrating additional details of a process for receiving user input according to one embodiment of the present invention. In this example, the process begins with displaying 505 an overlay layer. As noted above, the overlay layer can comprise the image of the user. An interface layer can be displayed 510 overlaid on the overlay layer. The interface layer can comprise one or more user interface elements including the target element of the user interface.

A hit-point layer can be monitored 515. The hit-point layer can correspond to both the overlay layer and the interface layer. As noted above, the hit-point layer can comprise a plurality of hit-point clusters corresponding to each of the one or more user interface elements. A determination 520 can be made as to whether movement of the user corresponds to the target element of the user interface based on detecting change to one or more pixels of at least one hit-point cluster corresponding to the target element. Detecting change to one or more pixels of the at least one hit-point cluster can be based on changes to pixels of the overlay layer corresponding to the at least one hit-point cluster.

As noted, each hit-point cluster can comprise a representation of a plurality of corresponding pixels of the overlay layer. The plurality of corresponding pixels can be arranged in a grid pattern. Detecting movement of the user can further comprise determining a direction of movement across the grid pattern based on changes to the corresponding neighboring pixels of the overlay layer. Therefore, the corresponding, target element can be manipulated 525 based on the hit-point detection and the system can be controlled based on manipulating the target element of the user interface.

In some cases, due to movement occurring within the field of view of the video camera other than the user, false detections and unintended activation of the user interface may occur. For example, a person or a pet walking into a room in which the camera is operating may inadvertently trigger the user interface. In another example the user standing up and/or walking away from the camera may inadvertently trigger the user interface.

In order to reduce these unintended activations, movement outside of the users immediate area can cause the user interface to be temporarily disabled. Generally speaking, reducing unintended activation of a user interface using video as an input can include receiving the video input from a camera, identifying a user within a field of view of the camera, determining a user area around the user, detecting movement in the field of view of the camera, and in response to the movement occurring outside of the user area, temporarily disabling the user interface.

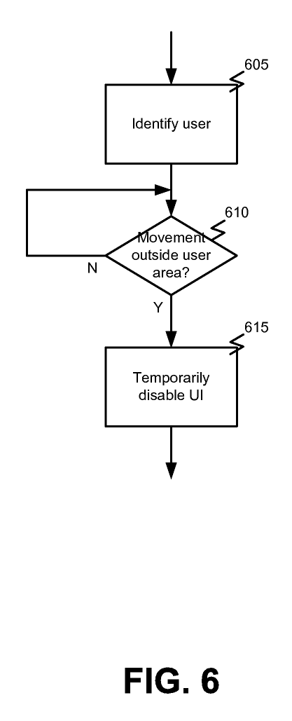

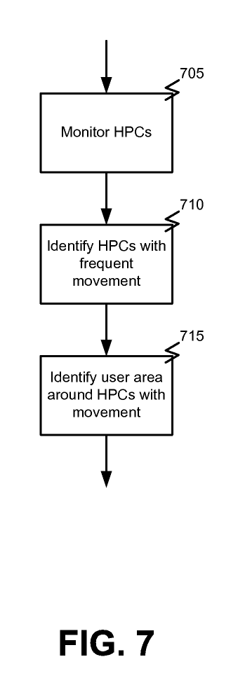

FIG. 6 is a flowchart illustrating a process for reducing unintended activation of a user interface using video as an input according to one embodiment of the present invention. In this example, the process begins with identifying 605 a user within a field of view of the camera. Identifying 605 a user within the field of view of the camera can be based on any of a number of algorithms such as, for example, algorithms for detecting a human face. Alternatively, identifying 605 a user within the field of view of the camera can be based on a method as described below with reference to FIG. 7. Identifying 605 the user can also include identifying a “user area.” That is, once the user is identified, a user area around the user can be determined. For example, hit-point clusters detecting movement or otherwise determined to correspond to the user and possibly those within a predefined radius, can be considered to be within the user area.

Movement can be detecting in the field of view of the camera as described above and a determination 610 can be made as to whether the movement is within the user area. In response to the movement occurring outside of the user area, the user interface can be temporarily disabled 615. Temporarily disabling 615 the user interface can comprise temporarily disregarding motion detected by the hit-point clusters. Temporarily disregarding motion detected by the hit point clusters can comprise disregarding motion detected by hit-point clusters outside the user area or all hit-point clusters.

Additionally or alternatively, the hit-point layer can comprise a plurality of edge hit-point clusters along each edge of the field of view of the video camera. In such a case, detecting movement outside the user area can comprise detecting movement at one or more edge hot-point clusters. For example, movement may be detected along an edge when someone walks into the field of view or the user suddenly moves out of the field of view. In either case, the interface can be temporarily disabled to prevent unintended activation.

FIG. 7 is a flowchart illustrating additional details of a process for identifying a user according to one embodiment of the present invention. In this example, the process begins with monitoring 705 the hit-point clusters. Identifying a user can comprise identifying 710 hit-point clusters repeatedly detecting movement within the overlay layer. That is, since people tend to move around or fidget, the user can be identified based on frequent movement. Thus, hit-points showing movement, for example beyond a predetermined threshold, can be considered as detecting the user. As noted above, a user area around the user can be identified 715. That is, hit-point clusters detecting the movement and possible those within a predefined radius of those hit-point clusters detecting movement, can be considered and defined to be within the user area.

In some cases, due to lighting conditions within an area or within the field of view of the camera, false detection of movement may occur. For example, the typical “wow and flutter” that occurs in digital video can cause a hit-point to falsely detect movement. In another example, a change in ambient lighting conditions, such as opening blinds or turning on lights in a room in which the camera is located can cause false detections. In yet another example, a reflection of the flicker of the television or monitor on a wall in an otherwise dark room may cause a false detection.

In order to reduce these false detections, light-point calibration of the hit-point clusters can be performed. Generally speaking, under light-point calibration, the hit-point layer can be divided into a number of zones and the sensitivity of the hit-point clusters within those zones can be adjusted based on the lighting conditions of that zone.

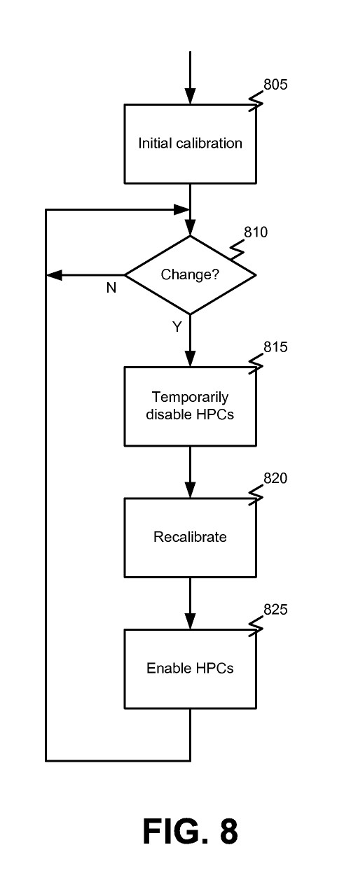

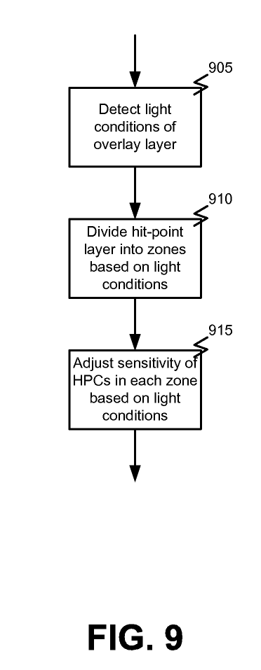

FIG. 8 is a flowchart illustrating a process for light-point calibration according to one embodiment of the present invention. In this example, the process begins with an initial calibration 805. That is, when the system is turned on or started, the ambient lighting conditions can be determined and the sensitivity of the hit-point clusters can be set. Details of calibration will be described further below with reference to FIG. 9. However, generally speaking, calibration can comprise detecting lighting conditions over a field of view of the camera, dividing the field of view into a number of zones, and adjusting sensitivity for detecting movement within each zone based on the lighting conditions of that zone.

After initial calibration 805 and upon the occurrence a change in the ambient lighting conditions as detected 810 by one or more hit-point clusters, further detection by the hit-point clusters can be disabled 815 temporarily. At this point, a recalibration 820 can be performed, for example as described below with reference to FIG. 9. That is, the lighting conditions over the field of view of the camera can be detected, the field of view can be divided into a number of zones, and the sensitivity for detecting movement within each zone, i.e., the sensitivity of the hit-point clusters, can be adjusted based on the lighting conditions of that zone. The hit-point clusters can then be re-enabled 825.

FIG. 9 is a flowchart illustrating additional details of a process for light-point calibration according to one embodiment of the present invention. In this example, the process begins, as noted above, with detecting 905 lighting conditions over a field of view of the camera. Detecting 905 lighting conditions over the field of view of the camera can comprise detecting lighting conditions based on the brightness of the pixels of the overlay layer.

The field of view can be divided 910 into a number of zones. Dividing 910 the field of view into a number of zones can comprise logically dividing the hit-point layer into a number of zones based on the lighting conditions, e.g., brightness of the pixels of the overlay layer. That is, the number of zones may be fixed or may be based on the lighting conditions, i.e., can be based on a severity of a gradient across the field of view wherein a greater number of zones are used when a larger gradient is encountered.

Sensitivity for detecting movement within each zone can be adjusted 915 based on the lighting conditions of that zone. Adjusting 915 sensitivity for detecting movement can comprise adjusting sensitivity of the hit-point clusters in each zone. For example, a value can be assigned to each hit-point cluster defining an amount of change in the corresponding pixels that would trigger a detection. Adjusting sensitivity for the hit-point clusters can comprise adjusting such values.

In the foregoing description, for the purposes of illustration, methods were described in a particular order. It should be appreciated that in alternate embodiments, the methods may be performed in a different order than that described. It should also be appreciated that the methods described above may be performed by hardware components or may be embodied in sequences of machine-executable instructions, which may be used to cause a machine, such as a general-purpose or special-purpose processor or logic circuits programmed with the instructions to perform the methods. These machine-executable instructions may be stored on one or more machine readable mediums, such as CD-ROMs or other type of optical disks, floppy diskettes, ROMs, RAMs, EPROMs, EEPROMs, magnetic or optical cards, flash memory, or other types of machine-readable mediums suitable for storing electronic instructions. Alternatively, the methods may be performed by a combination of hardware and software.

While illustrative and presently preferred embodiments of the invention have been described in detail herein, it is to be understood that the inventive concepts may be otherwise variously embodied and employed, and that the appended claims are intended to be construed to include such variations, except as limited by the prior art.

What is claimed is:

1. A method for providing user input to a system, the method comprising:
receiving an image of a user from a camera;
detecting movement of the user based on the image of the user;
determining whether the movement of the user corresponds to a target element of a user interface for the system; and
in response to determining that the movement of the user corresponds to the target element of the user interface, manipulating the target element of the user interface according to the movement of the user.

2. The method of claim 1, further comprising displaying an overlay layer, the overlay layer comprising the image of the user.

3. The method of claim 2, further comprising displaying an interface layer overlaid on the overlay layer, the interface layer comprising one or more user interface elements including the target element of the user interface.

4. The method of claim 3, further comprising maintaining a hit-point layer corresponding to both the overlay layer and the interface layer, the hit-point layer comprising a plurality of hit-point clusters corresponding to each of the one or more user interface elements.

5. The method of claim 4, wherein determining whether the movement of the user corresponds to the target element of the user interface is based on detecting change to one or more hit-points of at least one hit-point cluster corresponding to pixels of the target element and detecting change to one or more hit-points of the at least one hit-point cluster is based on changes to pixels of the overlay layer corresponding to the at least one hit-point cluster.

6. The method of claim 5, wherein each hit-point cluster comprises a representation of a plurality of corresponding pixels of the overlay layer, the plurality of corresponding pixels arranged in a grid pattern and wherein detecting movement of the user further comprises determining a direction of movement across the grid pattern based on changes to the corresponding pixels of the overlay layer.

7. The method of claim 1, further comprising controlling the system based on manipulating the target element of the user interface.

8. A method for reducing unintended activation of a user interface using video as an input, the method comprising:
receiving the video input from a camera;
identifying a user within a field of view of the camera;
determining a user area around the user;
detecting movement in the field of view of the camera; and
in response to the movement occurring outside of the user area, temporarily disabling the user interface.

9. The method of claim 1, wherein a scene within the field of view if the camera is logically divided into an overlay layer comprising the video from the camera, an interface layer comprising one or more user interface elements wherein the interface layer is overlaid on and corresponds to the overlay layer, and a hit-point layer corresponding to both the interface layer and the overlay layer and comprising a plurality of hit-point clusters corresponding to areas of the interface layer and the overlay layer.

10. The method of claim 2, wherein identifying a user comprises identifying hit-point clusters repeatedly detecting movement within the overlay layer.

11. The method of claim 3, wherein determining a user area comprises identifying hit-point clusters surrounding the user as being within the user area.

12. The method of claim 2, wherein temporarily disabling the user interface comprises temporarily disregarding motion detected by the hit-point clusters.

13. The method of claim 5, wherein temporarily disregarding motion detected by the hit point clusters comprises disregarding motion detected by hit-point clusters outside the user area.

14. The method of claim 2, wherein the hit-point layer comprises a plurality of edge hit-point clusters along each edge of the field of view of the video camera.

15. The method of claim 7, wherein detecting movement outside the user area comprises detecting movement at one or more edge hot-point clusters.

16. A method for reducing errors in a user interface using a camera as an input device, the method comprising:
detecting lighting conditions over a field of view of the camera;
dividing the field of view into a number of zones; and
adjusting sensitivity for detecting movement within each zone based on the lighting conditions of that zone.

17. The method of claim 1, wherein a scene within the field of view of the camera is logically divided into an overlay layer comprising an image received from the camera, an interface layer comprising one or more user interface elements wherein the interface layer is overlaid on and corresponds to the overlay layer, and a hit-point layer corresponding to both the interface layer and the overlay layer and comprising a plurality of hit-point clusters corresponding to each of the one or more elements of the interface layer.

18. The method of claim 2, wherein detecting lighting conditions over the field of view of the camera comprises detecting lighting conditions based on the overlay layer.

19. The method of claim 2, wherein dividing the field of view into a number of zones comprises logically dividing the hit-point layer into a number of zones based on the lighting conditions of the overlay layer.

20. The method of claim 4, wherein adjusting sensitivity for detecting movement comprises adjusting sensitivity of the hit-point clusters in each zone.

21. The method of claim 2, further comprising detecting a lighting condition change.

22. The method of claim 6, further comprising, in response to detecting the lighting condition change:
disabling the hit-point clusters;
detecting lighting conditions over a field of view of the camera;
dividing the field of view into a number of zones;
adjusting sensitivity for detecting movement within each zone based on the lighting conditions of that zone; and
enabling the hit-point clusters.
